(19) United States
(12) Patent Application Publication
(10) Pub. No.: US 2017/0138143 A1
(43) Pub. Date: May 18, 2017

(54) ACCUMULATOR FOR BLOWOUT PREVENTER CONTROL SYSTEMS

(71) Applicant: Don Darrell HICKMAN, Williston, ND (US)

(72) Inventor: Don Darrell HICKMAN, Williston, ND (US)

(21) Appl. No.: 15/336,462

(22) Filed: Oct. 27, 2016

Related U.S. Application Data
(60) Provisional application No. 62/247,072, filed on Oct. 27, 2015.

(51) Int. Cl. E21B 33/06; F15B 19/00; F15B 1/26

(52) U.S. Cl. CPC E21B 33/06; F15B 1/26; F15B 19/005

(57) ABSTRACT

A pressure accumulator control system for a blowout preventer includes a programmed logic control, a plurality of remote valves and a pressure monitoring and recording system. The control system monitors: accumulator pressure; valve manifold regulated pressure; annular regulated pressure; individual bottle manifold pressure; air operation pressure; nitrogen back-up system pressure; or open or closed function lines.

### BACKGROUND OF THE INVENTION

Field of the Invention

The present invention is directed to a blowout preventer control system having a modular configuration that provides for a range of control and monitoring features.

Description of the Prior Art

Blowout preventers are safety systems utilized with oil wells to prevent blowouts and the associated damage from a well blowout. Such systems close the top of the oil well hole and control fluid flow from the well. The blowout preventers provide for pressure release from the well. Such blowout preventers may be annular, ram type systems, rotational preventers or diverter type systems. Moreover, the blowout preventers may be used in series at the top of the well in a stack to provide several levels of safety and backup through redundancy. Such blowout preventers have various pressure ratings and are critical safety equipment.

In order to operate and close, blowout preventers require hydraulic pressure from an external source. Therefore, it is necessary to have a pressure accumulator system at the well to provide pressure to actuate the blowout preventer. Such pressure accumulators often take the form of a series of bottle type manifolds or tanks that provide multiple pressure sources that may be mixed and matched for the multiple blowout preventers. Each of the manifold units should maintain sufficient pressure to operate. It can be appreciated that as the wells are in a remote location and do not have an onsite maintenance crew, pressure may leak and full operational readiness may not be maintained.

It can therefore be appreciated that the individual pressure manifolds should be monitored so that the pressure of each unit is known. Such a system should also provide for monitoring from a remote location and for warnings to be provided should the accumulative pressure precharge fall below a predetermined level. Pressures that may be monitored and recorded by such a system include accumulator pressure, a valve manifold regulator pressure, annular regulated pressure, individual bottle manifold pressure, air operational pressure, nitrogen back-up system pressure and open and close function lines. It can be appreciated that it may be useful to have monitoring of one or more of these pressures depending upon the application and installation. Moreover, such a system should provide for a nitrogen precharge to safely provide sufficient pressure to the system. Such a system should also provide a fluid reservoir so that the necessary pressure may be maintained. The present invention addresses these as well as other problems associated with oil well blowout preventers and pressure accumulators.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### SUMMARY OF THE INVENTION

The present invention is directed to a pressure accumulator system for a blowout preventer. A pressure accumulator assembly has a control system including programmed logic control, a plurality of remote valves and a pressure monitoring and recording system. The control system monitors multiple parameters. The control system may monitor valve manifold regulated pressure, annular regulated pressure, individual bottle manifold pressure, air operation pressure, nitrogen back-up system pressure and/or whether function lines are opened or closed.

The present invention also includes a nitrogen pre-charge system for the blowout preventer pressure accumulator. The pre-charge system includes a plurality of separate individual bottles having hydraulic fluid therein. Each individual bottle includes an associated pre-charge system check. A warning system provides a warning if an individual bottle is not operating at predetermined performance levels.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings:

FIG. 1 is a perspective view of an air valve and control assembly for a blowout preventer accumulator system;

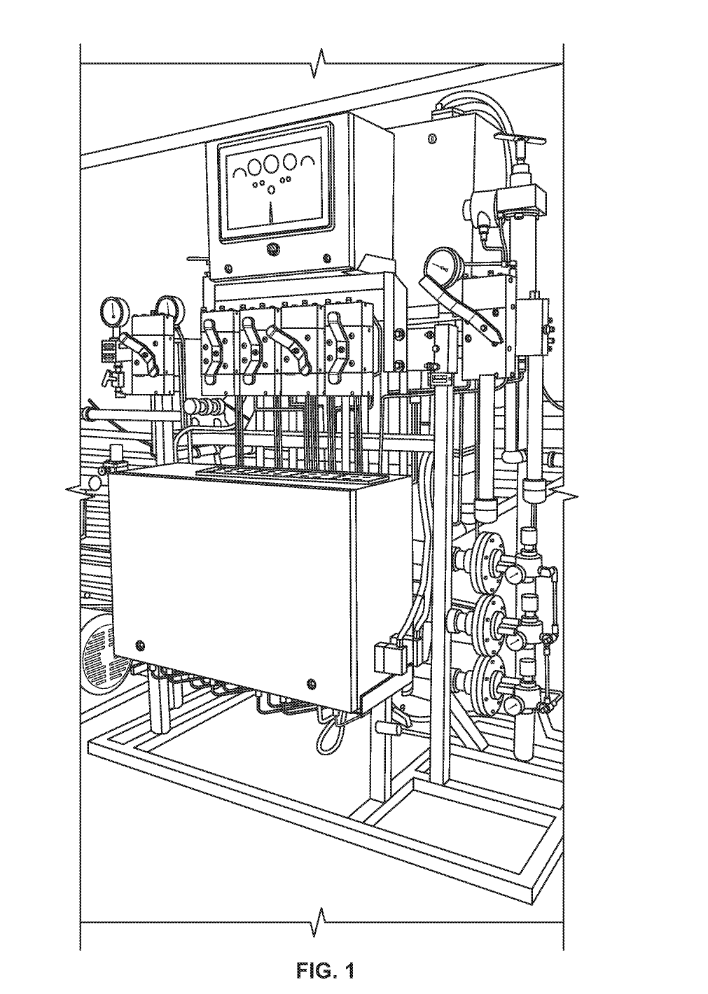

FIG. 2 is a front view of controls and gauges for system shown in FIG. 1;

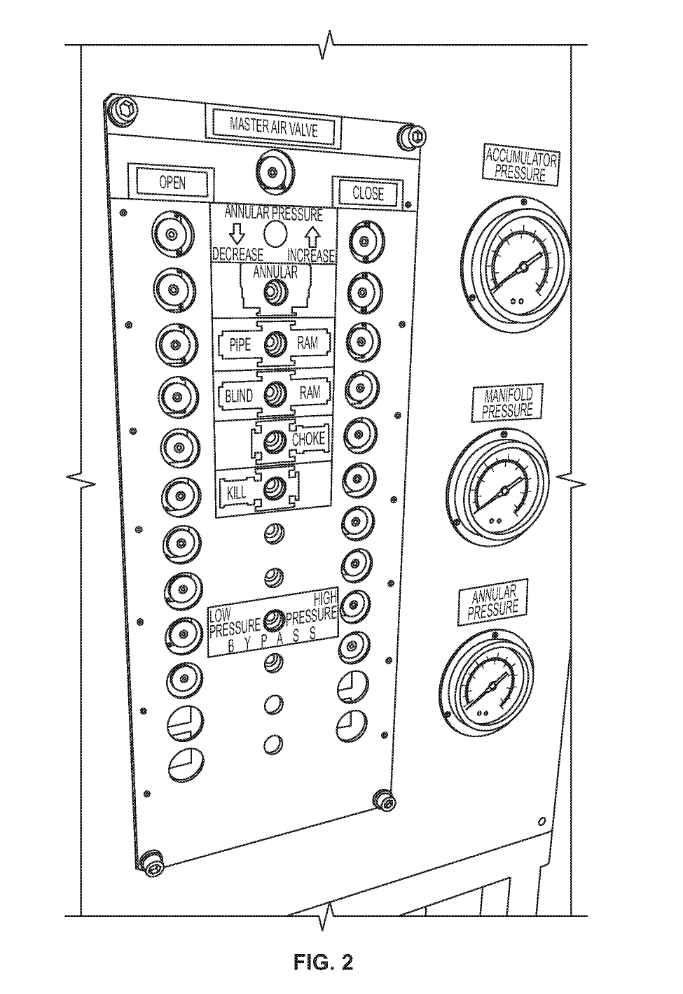

FIG. 3 is an exploded view of the walls of an accumulator tank;

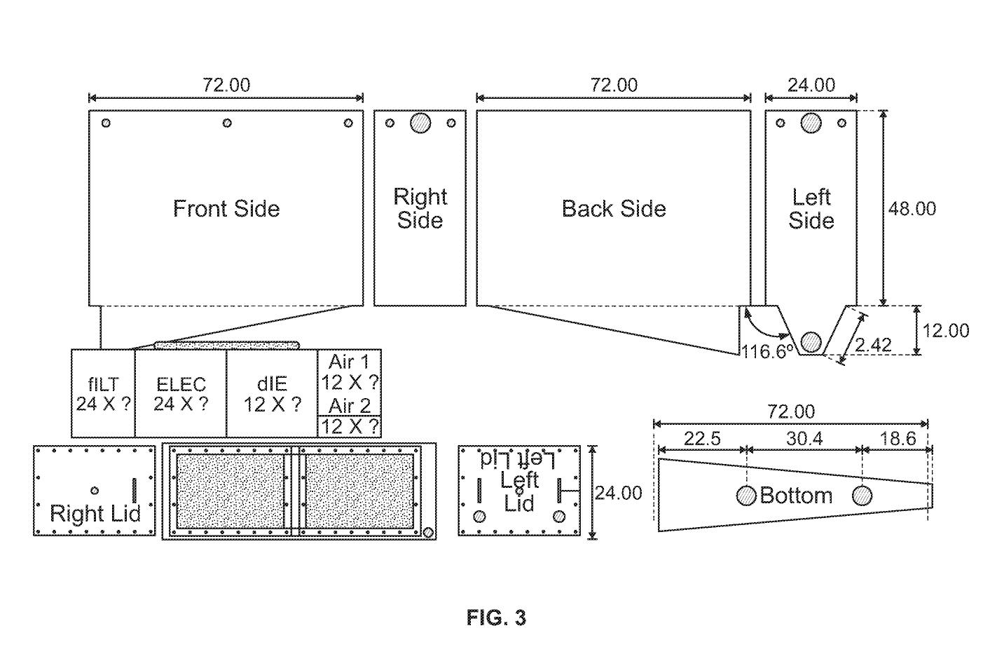

FIG. 4 is a perspective view of the assembly shown in FIG. 1;

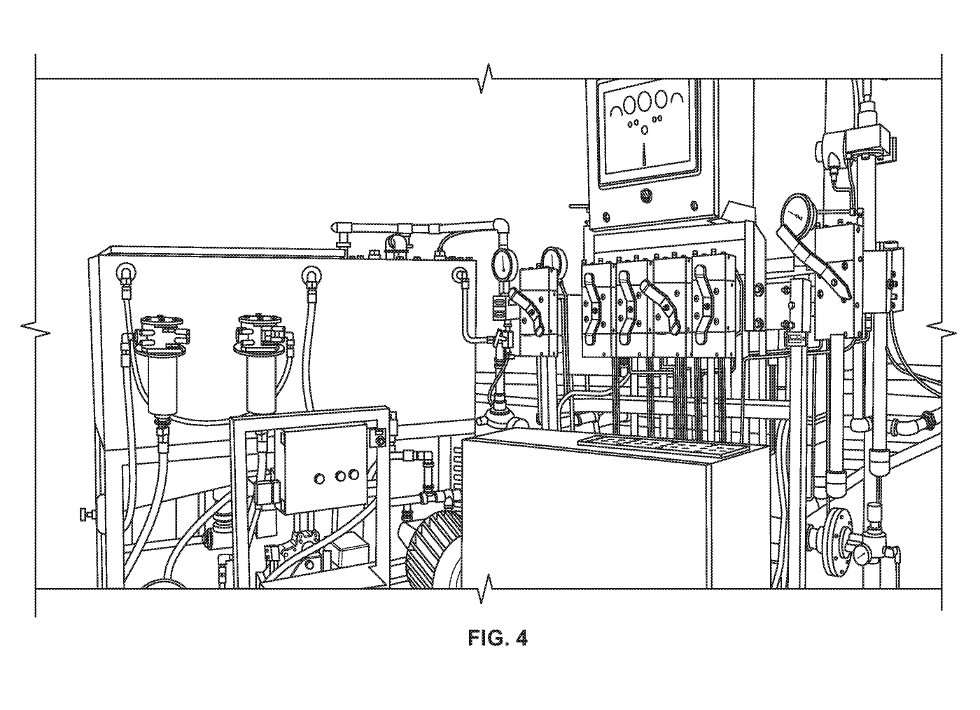

FIG. 5 is a perspective view of a control module for the assembly shown in FIG. 1;

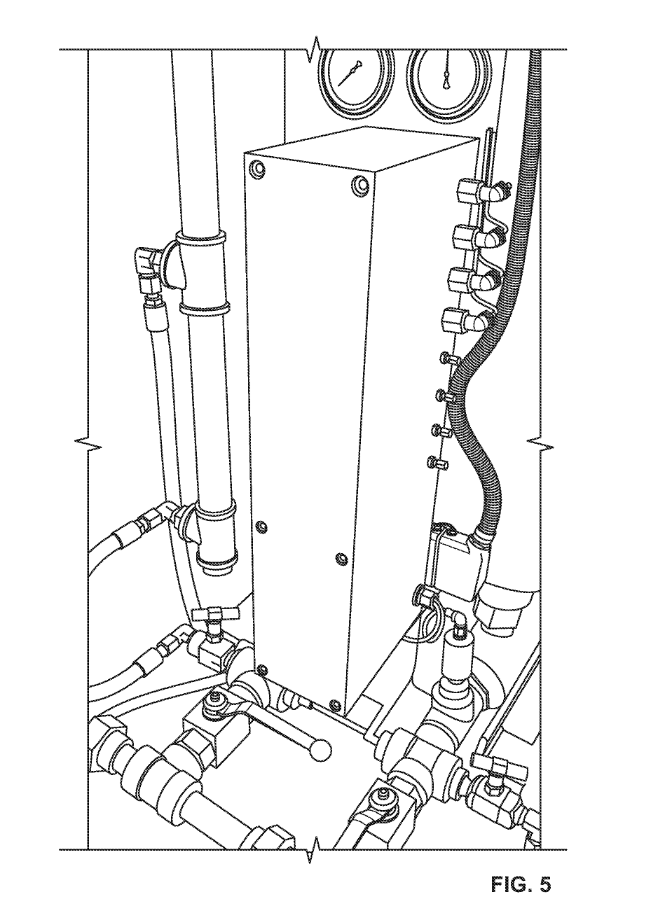

FIG. 6 is a perspective view of hydraulic valves and lines for the assembly shown in FIG. 1;

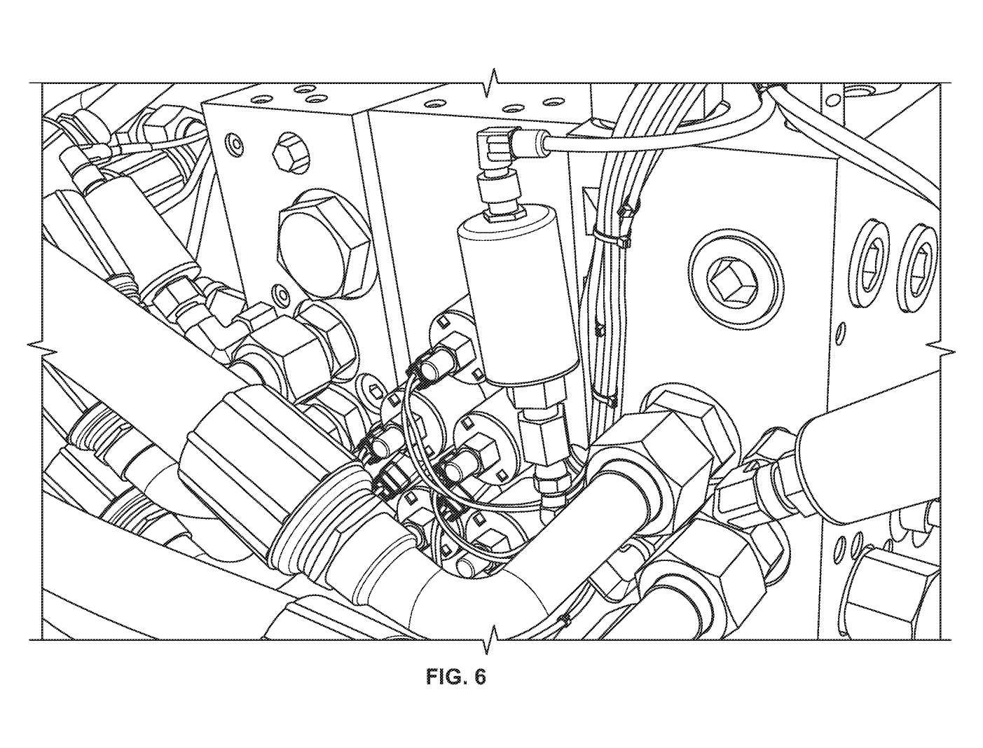

FIG. 7 is a perspective view of hydraulic valves and lines for the assembly shown in FIG. 1;

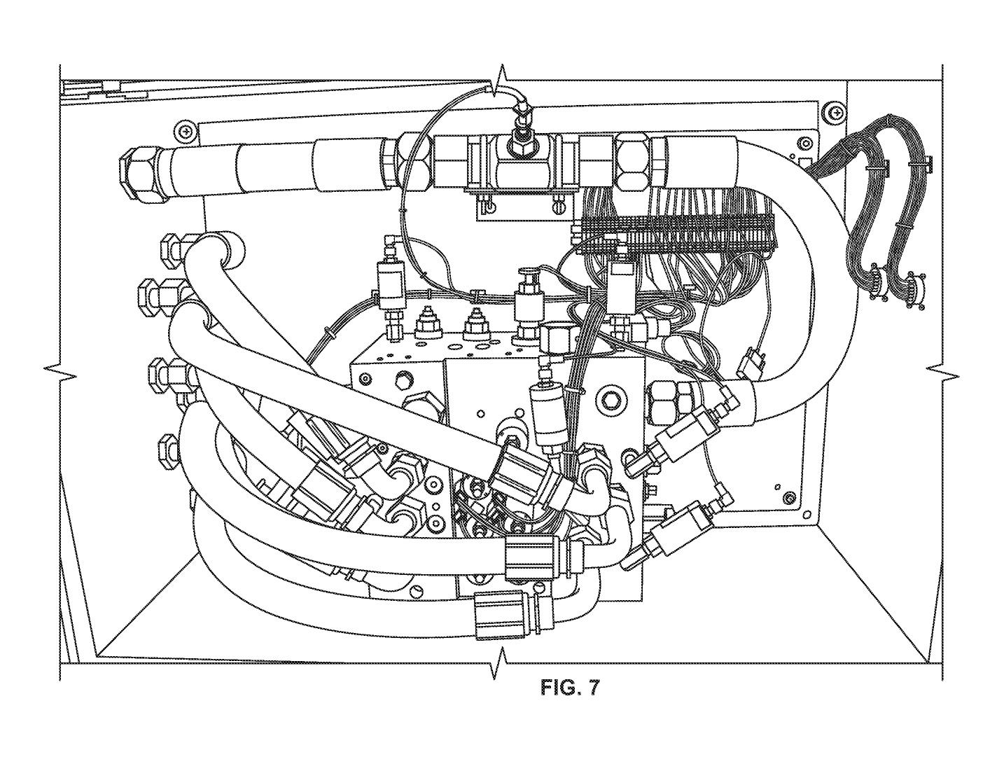

FIG. 8 is a perspective view of pumps and motors for the assembly shown in FIG. 1;

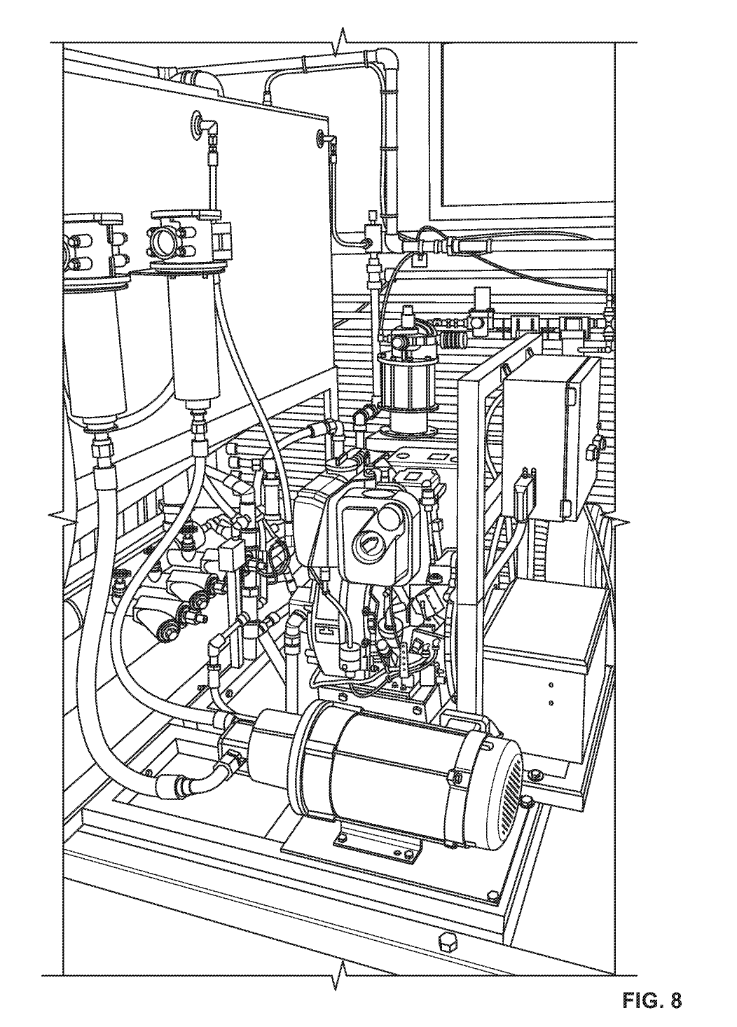

FIG. 9 is a detail view of the pumps and motors shown in FIG. 8;

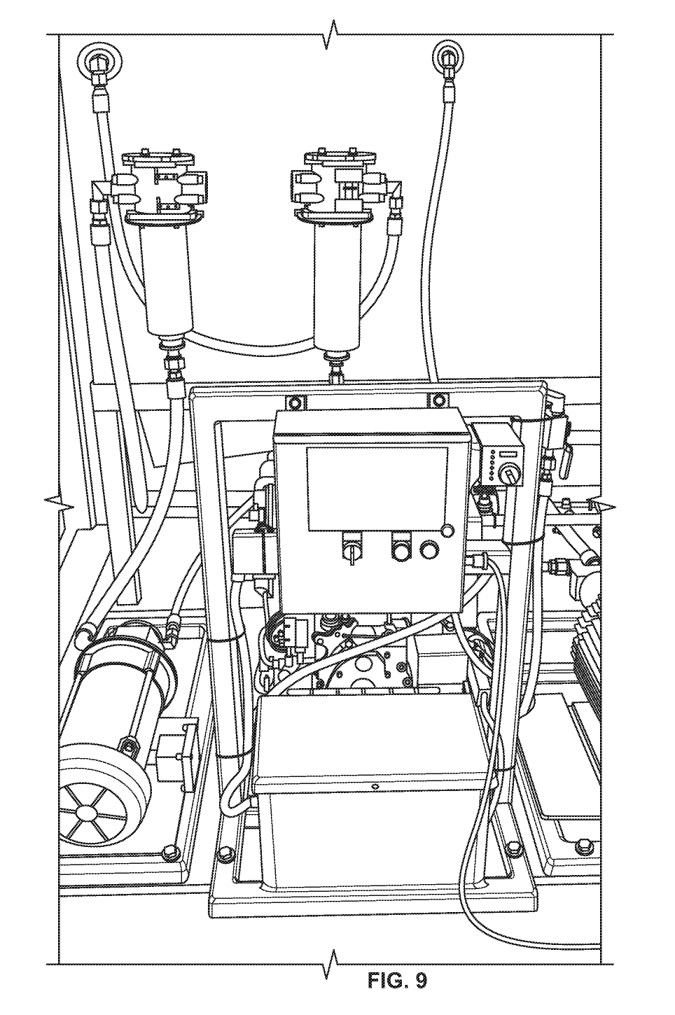

FIG. 10 is a front view of a monitoring and control panel for the control system;

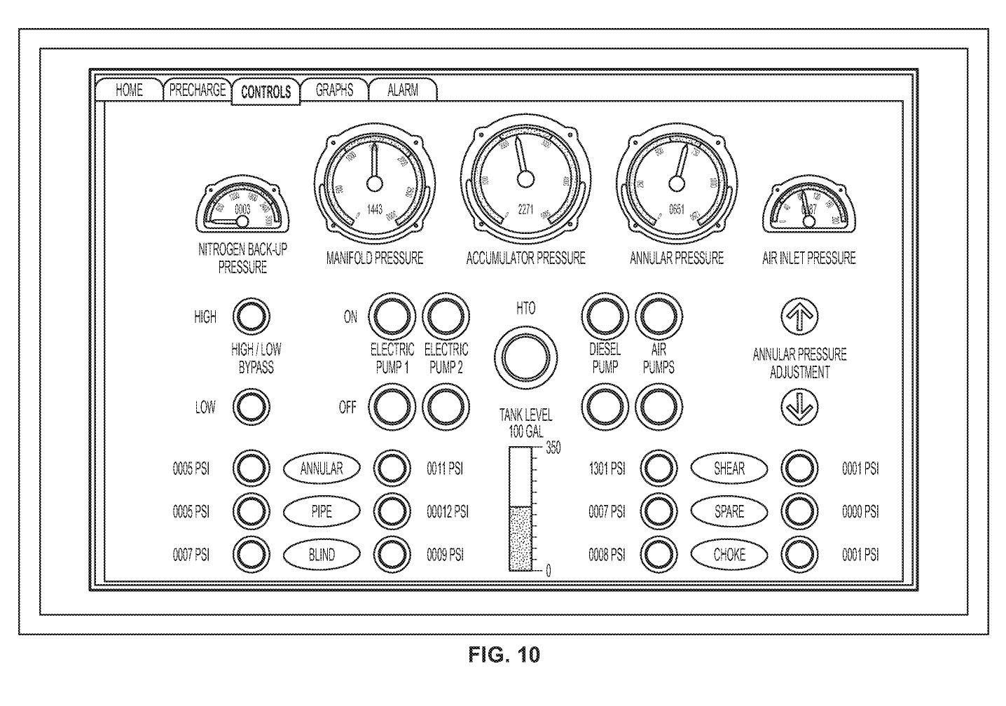

FIG. 11 is a perspective view of nitrogen pre-charge tanks for the system shown in FIG. 1; and

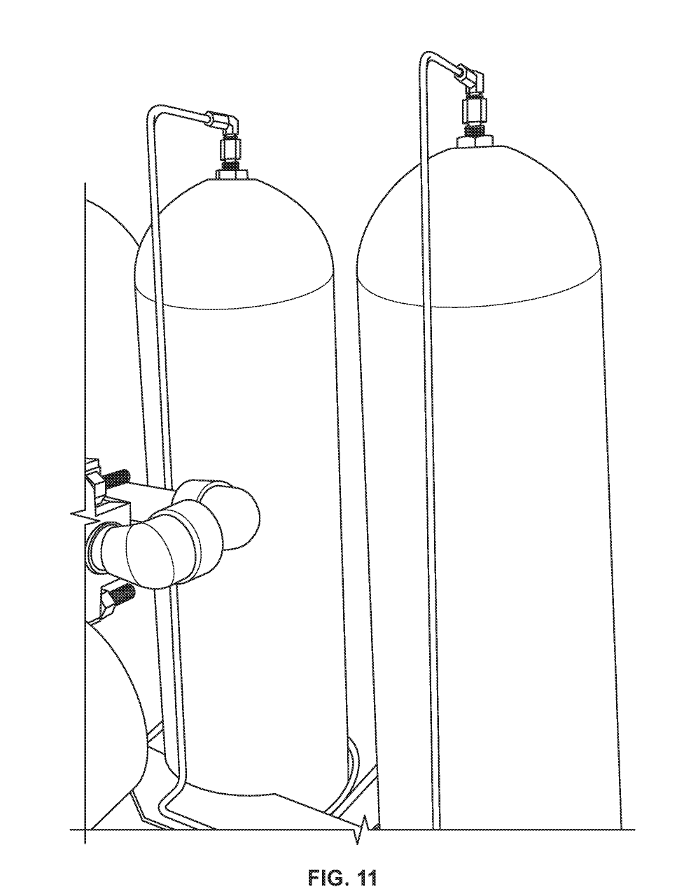

FIG. 12 is a detail view of a nitrogen pre-charge tank.

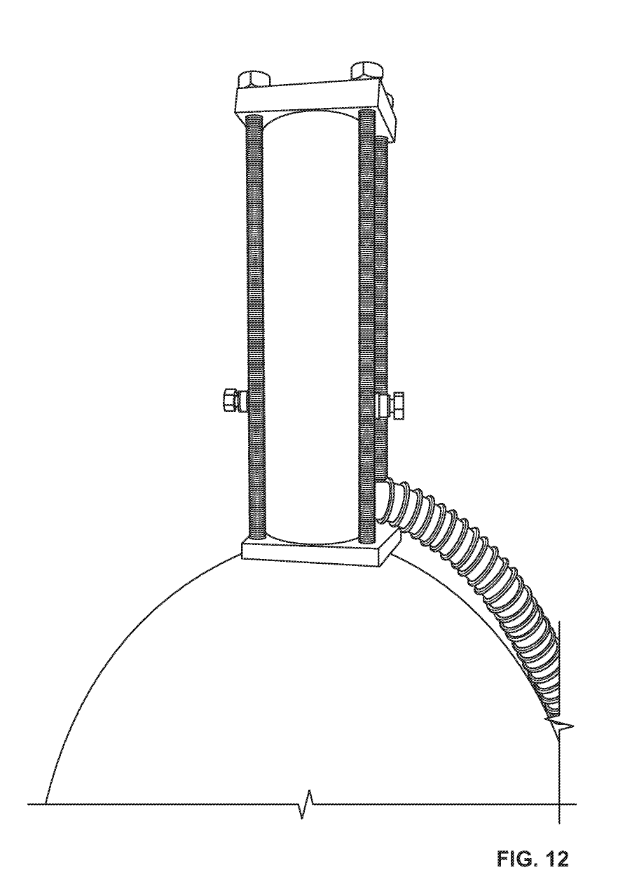

### DETAILED DESCRIPTION OF THE PREFERRED EMBODIMENT

The present invention relates to an accumulator for blowout preventer control systems. The accumulator unit has a modular design that provides for a many options to be added or configured to meet almost any requirement in the field.

The accumulator unit is unlike existing units that were specially build in design and do not allow for customization when needed.

The control system includes programmed logic controls. The programmed logic controller (PLC) provides visual and functional operation which includes a database for troubleshooting and recording critical operational data of the unit while in operation.

The control system includes an integrated air and electronic wired remote: The PLC enables the accumulator unit to be operated with pilot operated air remote valves that are coupled with the air remote system as well as using mechanical push button air valves that work together in a coordinated manner and not independently.

The control system has a full range of pressure monitoring and recording: The PLC enables hydraulic transducers to monitor the full range of operational pressures. Pressures monitored may include:

a. Accumulator Pressure

b. Valve Manifold Regulated Pressure

c. Annular Regulated Pressure

d. individual Bottle Manifold Pressure

e. Air Operation Pressure

f. Nitrogen Back-up System Pressure

g. Open and Close Function Lines

The control system includes a nitrogen pre-charge system check: The PLC enables and provides for an automated pre-charge check on each individual accumulator bottle. The control system monitors and identifies each accumulator bottle and displays the recordable nitrogen pre-charge pressure while providing for setting points for alarms and service needs.

The control system includes a digital display and operational controls: The PLC provides a full color indication of operating pressures, set points, fluid level, alarms, as well as functional touchscreen controls.

A hydraulic fluid reservoir provides for greater fluid management, which extends the service life of all components including the BOP cylinders and pistons. The sloped bottom of the reservoir provides for fluid contaminants and moisture to be directed directly to an automated filtration systems. Large oversized suction screens are internally raised and installed directly inline before the suction manifold and before external suction screens of the pumps. This configuration maintains the first level of protection by providing much cleaner fluids than is possible with previous filtration systems.

The accumulator system includes quick connect type “Plug In and Pump” hydraulic pump systems: Electric Powered Triplex Pumps, Gear Pumps, “Auto Start” Diesel Pumps, and Air Powered Pump modules are quickly installed and connected to meet various pumping applications and requirements.

The accumulator system has unitized accumulator bottle manifolds: The unitized accumulator manifolds are framed bottle manifolds. The manifolds are configured in various sizes for applications in which it is necessary to meet pressurized fluid requirements and provides for greater flexibility in accumulator unit design and certification needs.

An example pre-charge check would occur as follows:

pRECHARGE CHECK......dmc.txt

#AUTO
PreHigh=1200
PreLow=800
#LOOK
WT1000
MG 1
EV1=((@AN[0]−.89)* 1315.79)
MG EV1

IF (EV1 <=PreLow) | (EV1 >=PreHigh)

REM IS V1 LESS THAN OR EQUAL TO THE LOWER SETPOINT
AND GREATER THAN OR EQUAL TO HIGH SETPOINT. BN

SB 7

REM YES SET RED LIGHT.

MG “RED”
ELSE

REM NO

IF (EV1 >=PreLow)|(EV1 <=PreHigh)

REM THEN IS V1 GREATER THAN OR EQUAL TO THE LOWER
SETPOINT AND LESS THAN THE HIGH SETPOIINT.

SB 6
MG “GREEN”
ENDIF

ENDIF
WT1000
CB 7
CB 6

WT1000
MG 2
EV2=((@AN[1]−.89* 1315.79)
MG EV2

IF (EV2 <=PreLow) | (EV2 >=PreHigh)

REM IS V1 LESS THAN OR EQUAL TO THE LOWER SETPOINT
AND GREATER THAN OR EQUAL TO HIGH SETPOINT.

SB 5

REM YES SET RED LIGHT.

MG “RED”
ELSE

REM NO

IF (EV2 >=PreLow)|(EV2 <=PreHigh)

REM THEN IS V1 GREATER THAN OR EQUAL TO THE LOWER
SETPOINT AND LESS THAN THE HIGH SETPOIINT.

SB 4
MG “GREEN”
ENDIF

ENDIF
WT1000
CB 5
CB 4

WT1000
MG3
EV3=((@AN[2]−.89)* 1315.79)
MG EV3

IF (EV3 <=PreLow) | (EV3 >=PreHigh)

REM IS V1 LESS THAN OR EQUAL TO THE LOWER SETPOINT
AND GREATER THAN OR EQUAL TO HIGH SETPOINT.

SB 3

REM YES SET RED LIGHT.

MG “RED”
ELSE

REM NO

IF (EV3 >=PreLow) | (EV3 <=PreHigh)

pRECHARGE CHECK......dmc.txt

```
  REM THEN IS V1 GREATER THAN OR EQUAL TO THE LOWER
  SETPOINT AND LESS THAN THE HIGH SETPOINT.
```

SB 2
MG “GREEN”
ENDIF

```
  ENDIF
  WT1000
  CB 3
  CB 2
```

```
  WT1000
  MG 4
  EV4=((@AN[3]−.89)* 1315.79)
  MG EV4
```

IF (EV4 <=PreLow) | (EV4 >=PreHigh)

```
  REM IS V1 LESS THAN OR EQUAL TO THE LOWER SETPOINT
  AND GREATER THAN OR EQUAL TO HIGH SETPOINT.
```

SB 1

REM YES SET RED LIGHT.

```
  MG “RED”
  ELSE
```

REM NO

IF (EV4 >=PreLow) | (EV4 <=PreHigh)

```
  REM THEN IS V1 GREATER THAN OR EQUAL TO THE LOWER
  SETPOINT AND LESS THAN THE HIGH SETPOIINT.
```

SB 0
MG “GREEN”
ENDIF

```
  ENDIF
  WT 1000
  CB 1
  CB 0
```

JP#LOOK

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A pressure accumulator control system for a blowout preventer, the control system comprising:
programmed logic control;
a plurality of remote valves; and
pressure monitoring and recording system.

2. A control system according to claim 1, wherein at least one of the following parameters are monitored:
accumulator pressure;
valve manifold regulated pressure;
annular regulated pressure;
individual bottle manifold pressure;
air operation pressure;
nitrogen back-up system pressure; or open or closed function lines.

3. A nitrogen pre-charge system for a blowout preventer pressure accumulator, comprising;
a plurality of separate individual bottles having hydraulic fluid therein;
a pre-charge system check of each individual bottle;
a warning system providing a warning if an individual bottle is not operating at predetermined performance levels.

4. A pressure accumulator system for a blowout preventer, comprising:
a pressure accumulator assembly;
a control system for the pressure accumulator assembly, the control system comprising:
programmed logic control;
a plurality of remote valves; and
pressure monitoring and recording system.
